(19) United States
(12) Patent Application Publication
(10) Pub. No.: US 2016/0052082 A1
(43) Pub. Date: Feb. 25, 2016

(54) METHOD FOR REMOVING BRITTLE-HARD MATERIAL BY MEANS OF LASER RADIATION

(71) Applicants: WOLFGANG SCHULZ, LANGERWEHE (DE); URS EPPELT, AACHEN (DE)

(72) Inventors: WOLFGANG SCHULZ, LANGERWEHE (DE); URS EPPELT, AACHEN (DE)

(21) Appl. No.: 14/779,646

(22) PCT Filed: Mar. 21, 2014
(86) PCT No.: PCT/EP2014/000778

§ 371 Date: Sep. 24, 2015

(30) Foreign Application Priority Data
Mar. 26, 2013 (DE) 10 2013 005 136.3

(51) Int. Cl. B23K 26/00; C03B 33/02; B23K 26/361

(52) U.S. Cl. CPC B23K 26/0006; B23K 26/361; C03B 33/0222

(57) ABSTRACT

Laser radiation is used for removing brittle-hard material from a substrate without damaging the material. A removal depression having a flank angle w of the flanks of the removal depression forms in the material as a result of the removal. The removal depression forms with an entry edge, which is defined as a spatially expanded region of the surface of the material, where an unchanged and thus unremoved portion of the surface of the material transitions into the removal depression. Spatial portions of the laser radiation are refracted and focused into the volume of the unremoved material at this entry edge. The distribution of the laser radiation is set such that the entry edge assumes a small spatial expansion, such that the portion of the power of the laser radiation, which is captured by the focusing effect of the entry edge, is not sufficient to generate a threshold value ρ_{damage} for the electron density in the volume of the material, thus avoiding damage to the material.

### BACKGROUND OF THE INVENTION

The invention relates to a method for removing, for example cutting, scoring, drilling, brittle-hard material by means of laser radiation, wherein a removal depression having a flank angle w of the flanks of the removal depression forms in the material as a result of the removal, wherein the flank angle w is defined as the angle between the surface normal on the flank of the removal depression and the surface normal on the unremoved surface of the material, and forms with an entry edge, which is defined as a spatially expanded region of the surface of the material, where an unchanged and thus unremoved portion of the surface of the material transitions into the removal depression, and at which spatial portions of the laser radiation are refracted and focused into the volume of the unremoved material.

Such methods are used in display technology, among other fields, where thin glass substrates, a brittle-hard material, must be machined. In particular, the industrial display technology conquers an increasing market volume and the trend is towards always-lighter equipment and therefore thinner glass panes, for example for smart phones and tablet computers.

Thin glass substrates offer advantages especially for displays if the durability and mechanical stability of thicker glass can be achieved. These thin glass panes are used in almost all flat panel displays (FDP's).

Conventional methods for machining such thin panes of glass are milling with defined cutters, or are based on mechanical effects of a crack formation (scoring and breaking) introduced in a defined manner into the material. A variety of known process variants using laser radiation is also based on utilizing the mechanical effects of the principle of scoring followed by breaking, where the effects of the laser radiation replace scoring and the material is broken after the effect of the laser radiation. Conventional machining (cutting, drilling) is much more difficult for thin glass panes than for large material thicknesses. With mechanical scoring, micro-cracks are introduced or even small parts, so called chips, are pried out, such that sanding or etching becomes necessary for post-processing.

It has been shown that the surfaces or flanks, respectively, of the removal surfaces formed in the material have a diffractive or refractive effect on the introduced laser radiation. This produces interference diffraction patterns through radiation portions of the laser radiation. As soon as these radiation portions again incise on the surfaces of the removal depression, the respective surface is roughened; the refractive effect of the roughness results in focusing of the laser radiation and cracks can be caused in the adjacent material. In addition, the entry edge in the region of the forming removal depression has a very large impact on the formation of the removal depression and the forming of cracks. Damage in the shape of cracks arises from this entry edge, and the laser radiation that incises on the entry edge appears to be the cause of it.

US 2006/0091126 A1 describes a method and a laser system for machining substrates of silicon, gallium arsenide, indium phosphite or a monocrystalline sapphire, to generate micro-structure patterns therein, using ultraviolet lasers. Here, two laser beams are superimposed to create finely structured removal depressions with low depths. According to this method, only a small depth of the removal indentation—a structuring—is created, such that an optical effect of a removal depression is negligibly small. In addition, the material surface should be removed such that a fine structure arises with as many right-angled, sharp edges as possible in a confined space.

US 2011/0240616 A1 describes a singulation method of brittle electronic substrates into small cubes using a laser. As FIGS. 4 and 5 show, the singulation is carried out in two steps. In a first step a shallow hole is made (initial cut) with low power and a small removal rate and obviously a small heat-affected zone in the area of the edge of the hole. Although this leads to the reduction of debris, it does not lead to the avoidance of damage by a focusing of laser radiation into the material during the second partial step, in which a second, deep hole with an extended edge with unwanted focusing on the place of the bottom of the hole of the first, shallow hole (initial cut) is generated.

US 2010/0176103 A1 relates to a method and a device for the material removal to a predetermined removal depth from a workpiece. A laser beam is used consisting of one or more sub-beams, each of the latter having a defined beam axis, whereby the axis of the laser beam or the individual axes of the sub-beams are guided along a removal line at a predetermined travelling speed and the laser beam has a predetermined spatial energy flow density that defines a Poynting vector S with a value I₀f(x) and a direction s, the spatial energy flow density creating a removal face with an apex formed by the leading portion of the removal face in the removal direction and said face creating a removal edge. The respective incident angles α of the removal face formed by the normal vectors n of the removal face and the directions s of the Poynting vectors are set in such a way that they do not exceed a maximum value αₘₐₓ in a predefined region around the apex of the removal face. If the maximum value is exceeded this is detected in the change from a small gouge amplitude in an upper portion of the removal edge to a large gouge amplitude in a lower portion of the removal edge.

US 2011/240616 A1 relates to a method for laser machining brittle workpieces, providing a laser having laser parameters, making a first cut in the workpiece with the laser using first laser parameters, and making a second cut in the workpiece with the laser using second laser parameters, the second cut being substantially adjacent to the first cut while generally avoiding the debris cloud created by the first laser cut. This reference also discloses an apparatus for laser machining a brittle workpiece comprising a laser having laser pulses and laser pulse parameters, laser optics operative to direct the laser pulses to the workpiece, motion stages operative to move the workpiece, and a controller operative to control the laser pulse parameters, the motion stages and the laser optics. The laser is operative to machine the workpiece at a first location with first laser parameters by means of the controller in cooperation with the laser, laser optics and motion stages, and then the laser is operative to machine the workpiece at a second location adjacent to the first location with second laser parameters while avoiding a debris cloud created by machining at the first location.

### SUMMARY OF THE INVENTION

The principal objective addressed by the invention is that of providing a method that avoids or at least prevents to a large degree the damages described above, which, in particular arise from the entry edge or the cause of which can be traced to the laser radiation that impacts the entry edge.

This objective is achieved in accordance with the present invention by setting the distribution of the laser radiation such that the entry edge assumes a small spatial expansion, such that the portion of the power of the laser radiation, which is captured by the focusing effect of the entry edge, is not sufficient to generate a threshold value ρ_{damage} for the electron density in the volume of the material, thus avoiding damage to the material.

It is essential for the method according to the invention that the distribution of the laser radiation is be set such that the entry edge assumes a small spatial expansion, such that the portion of the power of the laser radiation, which is captured by the focusing effect of the entry edge, is not sufficient to create a threshold value ρ_{damage} for the electron density in the volume of the material thus avoiding a damage to the material.

Thus, the power of the laser radiation, which is captured by the focusing effect of the entry edge, is set such that the intensity in the material, which is achieved by focusing of the entry edge, does not reached a threshold value ρ_{damage} for damaging the material. According to the method according to the invention, the power is not simply reduced and a low-damage first hole produced, but cutting is performed in one step with great power and only the portion of the power that leads to damage is reduced.

The measure according to the invention utilizes the insight that the effect of focusing on the entry edge into the volume is a relevant effect, which is to be avoided.

Through this measure, the damages arising from the entry edge are significantly reduced or even avoided, since this reduces the intensity of laser radiation thus avoiding a spatially localized and thus excessive stress of the brittle-hard material.

As mentioned above, cracks arise during mechanical machining of thin glass panes. However, such cracks can also be observed when processing the glass panes with laser radiation. It has been discovered that these cracks appear in at least three different forms:
Cracks of the first kind: Damage/cracking/chipping occurs on the back side of the material. Cracks of the first kind occur already even if no damage and no removal has yet occurred on the front side—from where the laser radiation impinges (impacts).
Cracks of the second kind: Cracks or damage—also referred to as spikes—arise from the entry edge that represents the transition from the unchanged part of the material surface to the side removal flanks of the forming removal depression.

Cracks or damages of the second kind run across a great depth into the volume of the material—compared to the cracks of the third kind. These material modifications/damages arising from the entry edge can become visible or arise also in the volume (they are then also called “filaments”; Kerr effect and auto focusing are the physical causes) or reach even the backside, or the side of the surface of the workpiece that faces away from the laser radiation.
Cracks of the third kind: The forming of fine, not as deeply penetrating cracks occurs in addition to the cracks or damages of the second kind—along the removed surface (cut edge); they are not restricted to the area near the entry edge and occur where the laser radiation incises in the removal depression onto the removed surface; i.e., the removal flanks. From the removed surfaces, they spread into the material. Compared to the cracks of the first kind, the cracks of the third kind penetrate less deeply into the material. Compared to the entry edge, the rough surface of the removal depression has a roughness with smaller curvature radii. The focusing effect of the rough surface of the removal depression is significantly stronger than the focusing effect of the entry edge.

Thus, when compared to conventional methods, the method according to this invention avoids or at least significantly reduces these cracks of the third kind.

Preferably, with the method according to the invention, the Poynting vector P is set by the portion of the laser radiation incident on the unremoved surface of the material in the region of the removal depression tilted toward the entry edge, and the incident angle w_{E} of the laser radiation is selected such that it is not less than zero (w_{E}>=0 angular degrees), wherein the incident angle w_{E} is defined as the angle between the Poynting vector P of the laser radiation and the normal vector of the surface impacted by the laser radiation.

It can also be advantageous to set the Poynting vector P by the portion of the laser radiation that impacts the removal depression in the region of the removal depression, perpendicular to the normal vector n_{F} on the flank of the removal depression, and to select the incident angle w_{E} of the laser radiation with w_{E}=90 angular degrees, wherein the incident angle w_{E} is defined as the angle between the Poynting vector P of the laser radiation and the normal vector of the surface that is impacted by the laser radiation.

One advantageous embodiment of the inventive method arises when the spatial distribution of the laser radiation at the entry into the removal depression is set to be rectangular. This achieves an area of the entry edge with a small expansion, thus making small the portion of the laser radiation that is captured by the region of the entry edge and focused into the material.

Also, the spatial distribution of the laser radiation at the entry of the removal depression can be set in a Gaussian shape viewed perpendicular to the incident direction of the laser radiation; and the Gaussian-shaped distribution is truncated rectangle-shaped at a distance from the beam axis, where the intensity in the volume of the material reaches a threshold value ρ_{damage} for the damage to the material; for greater distances from the beam axis, the intensity of the laser radiation is set to zero, also referred to as Gaussian rectangle. The laser beam axis is defined by the mean value of the Poynting vectors averaged over the cross-section of the laser beam. The direction of the laser radiation varies across the cross-section of the laser beam and is defined by the local direction of the Poynting vector. Typically, the Poynting vectors are tilted to the laser beam axis above the focus of the laser beam and pointed away from the laser beam axis below the focus. A Gaussian-rectangular-shaped distribution of intensity in the laser beam is defined as a Gaussian-shaped distribution that no longer has an intensity from a defined distance from the laser beam axis—through an aperture, for example. Mathematically, a Gaussian rectangle is the multiplication of a Gaussian distribution with a rectangular distribution having the maximum value of 1. A rectangular distribution refers to a 2-D rectangular distribution that has been rotated around the laser beam axis.

The removal using the specified method for removing brittle-hard materials by means of laser radiation forms a removal depression in the material, with areas also referred to as flanks that act diffractive and refractive upon the introduced laser radiation and thereby generate radiation portions of this laser radiation interference diffraction pattern inside the removal depression. As soon as these radiation portions impact again the surfaces of the removal depression and penetrate the material volume, they effect there a spatially changeable removal along the surfaces and as a consequence roughen the surface and induce cracks in the material volume.

In another embodiment of the method, a wavelength mixture of at least two wavelengths is used for the laser radiation for the removal, wherein the at least two wavelengths are selected such that interference diffraction patterns arise due to the diffraction and refraction along the surfaces of the removal depression and in the material volume compared to laser radiation of only one of the wavelengths such that a contrast K in the spatial structure of the intensity distribution is reduced, wherein the contrast K according to Michelson is defined as K=(Imax−Imin)/(Imax+Imin), wherein Imax and Imin indicate the maximum and minimum intensity of the spatial structure of the intensity distribution. Here, the contrast K according to Michelson is a measure for the periodic pattern of refraction maxima and refraction minima.

These measures reduce the intensity contrast in the area of the surface of the flanks of the removal depression and in doing so avoid spatially localized and thus excessive stress of the material, namely as a consequence of the fact that laser radiation with two different wavelengths that are superimposed is used for machining the brittle-hard material.

This is because a superimposition of laser radiation of different wavelengths produces a diffraction pattern that is spatially offset in the removal depression for each wavelength. Selecting the appropriate wavelengths of the used radiation portions, the powers and the focus radii of the (at least two) wavelengths to be superimposed, the diffraction maxima of the laser radiation with the first wavelength can occur in those locations, where the diffraction minima of the laser radiation with the second wavelength are located. As a result of this superimposition, the contrast of the superimposed diffraction structure becomes much smaller with the result that a removal rate and, if at all, low tensions and/or cracks are achieved after the removal.

The wavelengths of the radiation portions that are to be superimposed as well as the powers belonging to the wavelengths and the associated focus radii of the radiation portions must be adapted to achieve the smallest contrast.

In one preferred embodiment of the method, a wavelength mixture is selected from the at least two wavelengths such that spatial positions of interference maxima of the one wavelength(s) occur in the interference minima of the other wavelength(s), thus achieving that the removal flank is not roughed up and thus also the focusing effect of the rough removal edge is not formed, and thus the threshold value for the removal pd me at which damages/cracks occur is not reached.

Furthermore, radiation portions of the laser radiation can be used in addition to the at least two radiation portions, having wavelengths of integer multipliers or divisors of the at least two wavelengths, which can be referred to as base wavelengths.

A separate laser can provide each wavelength. This has the advantage that the focus radii and the power portions of the different wavelengths of the laser radiation can be set. If the laser source allows a modulation of the wavelength, the different wavelengths can be provided by one laser source or one laser device, respectively.

If the laser source emits several wavelengths, as is the case with diode lasers, for example, the different wavelengths can be provided by one laser source or one laser device, respectively, whose wavelength is modulated.

For a full understanding of the present invention, reference should now be made to the following detailed description of the preferred embodiments of the invention as illustrated in the accompanying drawings.

### BRIEF DESCRIPTION OF THE DRAWINGS

FIG. 1 shows schematically a removal depression identifying the various crack formations/damages of a second and third kind.

FIG. 2 shows a simulated removal depression illustrating the spread of the formed cracks of the second and third kind.

FIG. 3 is a schematic diagram to explain the creation of a removal depression with rough removal flanks.

FIG. 4 shows the diffraction pattern caused by diffraction of incident laser radiation on the removal flanks.

FIG. 5 illustrates the principle of the formation of a crack of the second kind (figures a, b) and the principle of the method according to the invention to avoid or at least suppress these cracks (images c, d).

FIG. 6 shows a simulated removal depression that has been created with a top-hat-shaped distribution of the intensity of the laser radiation.

FIG. 7 shows a view according to FIG. 6, however with a spatial distribution of the intensity of the laser radiation that is comprised of a top-hat distribution and a Gaussian distribution.

FIG. 8 shows a view according to FIG. 6 with a narrow, spatial Gaussian distribution of the intensity of the laser radiation using a laser radiation with a beam radius <4 μm.

FIG. 9 shows a view according to FIG. 6 with a spatial top-hat distribution of the laser radiation at the entry into the removal depression.

FIG. 10 shows a sequence of images a to e to explain the formation of cracks of the third kind.

FIG. 11 shows in a magnified simulation representation the contrast of the spatial distribution of the intensity in the removal depression according to image a of FIG. 5.

### DESCRIPTION OF THE PREFERRED EMBODIMENTS

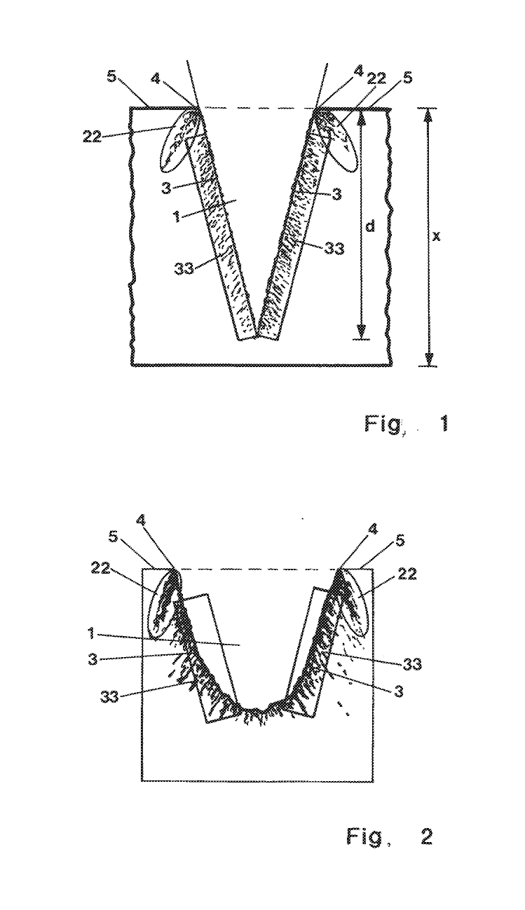

The preferred embodiments of the present invention will now be described with reference to FIGS. 1-11 of the drawings. Identical elements in the various figures are designated with the same reference numerals.

The representation of FIG. 1 shows schematically a V-shaped removal depression 1 that is formed in a thin glass material 2 with a thickness x. This removal depression 1 has removal flanks 3 originating from an entry edge 4 on the surface 5 of the material.

The following definitions apply to the various terms that are used here:

Threshold value ρ_{ablation} is the threshold value of the electron density at which an ablation/a removal starts,

Threshold value ρ_{damage} is the threshold value of the electron density at which damages/cracks start,

Pulse parameter is a set of parameters for characterizing the spatial, time and spectral properties of the incident laser radiation. The pulse parameter includes at least the values for
Pulse duration,
Intensity maximum value in the pulse,
Pulse shape over time; this refers to the distribution of the intensity of the laser radiation over time in one single pulse or in a sequence of pulses (multi-pulse, pulse burst),
Spatial distribution of the intensity, and
Spectral distribution of the intensity (wavelength mixture).

The entry edge is a spatially expanding area of the workpiece's surface, where an unchanged portion of the workpiece's surfaces transitions into the portion of the surface, where material removal has taken place and a removal depression has developed.

The rim of the removal depression is a surface created by the material removal.

The backside or bottom side of the workpiece is the surface of the workpiece that points away from the laser radiation.

The three different forms of damages/cracks explained above are

Backside damages for cracks of the first kind,
Entry edge damages for cracks of the second kind,
Damages originating from the surface of the removal depression, i.e. from the flanks of the removal depression, for cracks of the third kind.

Two threshold values ρ_{damage}, ρ_{ablation} are defined for the electron density ρ in the material that cause either damage ρ_{damage} to or a removal ρ_{ablation} of the material. For each material these different threshold values ρ_{damage}, ρ_{ablation} for the electron density p, where ρ_{damage}<ρ_{ablation} is, can be associated with two sets of values for the parameters of the laser radiation.

A light-refracting property, for example a focusing property, of the entry edge is of particular importance for the invention. This is because the entry edge can have a geometric shape and an extension that can cause two unwanted effects, which, however, can be avoided or significantly reduced by the method according to the invention. On the one hand, unwanted focusing of the incident laser radiation into the material can occur due to the geometric shape, and on the other hand, the power of the incident laser radiation that is captured by the entry edge and then focused into the material can assume a value in an unwanted fashion due to the extension, such that the intensity of the focus of the entry edge generates an electron density p, which exceeds the threshold value ρ_{damage} of the electron density for damage to the material and does not reach the threshold value ρ_{ablation} of the electron density for removal.

The three different kinds of cracks that have already been explained above occur when the material is damaged.

Cracks of the first kind are those that occur already even if no damage and also no removal has yet occurred on the front side (where the laser radiation incides).

Cracks of the second and third kind that are illustrated based on FIGS. 1 and 2.

In FIGS. 1 and 2, cracks of the second kind are marked with the reference sign 22 and cracks of the third kind with the reference sign 33.

If the cracks 22 originating from the removed surface reach the bottom side, or the surface of the workpiece pointing away from the laser radiation, they often cannot be distinguished from the cracks of the first kind, i.e., damage to the workpiece's bottom side without the top side of the workpiece having already been removed. Cracks or damages of the third kind start at the rough removal depression, i.e. on the removed surface, and at the location, where the removed surface has deviated from the flatness.

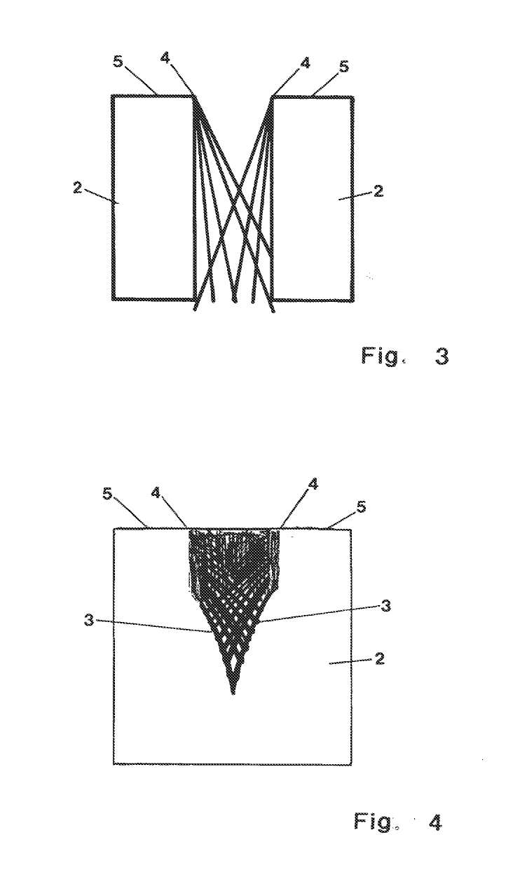

This deviation of the removal depression from the flatness arises due to the refraction of the incident laser radiation at the entry of the removal depression and in its progression in the depth of the workpiece (removal front, cut edge) and has a diffraction structure, as shown in FIGS. 3 and 4.

This diffraction structure is a spatial modulation of the intensity and results in the deviation from a flat removal front. The resulting diffraction structure for the intensity of the radiation in the removal depression leads to intensity peaks on the removal front and thus to a deviation of the removal front from a smooth or flat removal front.

According to the invention, in order to avoid the occurrence of cracks of the second kind in the form of damage/crack development originating from the entry edge of the material to be machined, the power of the laser radiation, which is captured by the focusing effect of the entry edge, is set such that the intensity in the material, which is achieved by focusing of the entry edge, does not reach a threshold value ρ_{damage} for damaging the material.

FIG. 5 shows an image sequence, wherein images a) and b) illustrate the principle of the formation of a crack of the second kind, while the image sequence with the images c) and d) serves to illustrate the measures according to the invention in order to avoid or significantly reduce the formation of such cracks of the second kind.

The respective entry edges of a removal depression are indicated in images 5a) and 5b) by the area 40. Thus, this entry edge comprises a spatially expanding area 40 where the laser radiation is focused. In images 5c) and 5d), the spatially expanding area 40 is associated with the removal depression through its position as a transition area from the non-removed surface into the flank of the removal depression.

FIG. 5c shows that the Poynting vector P is set by the portion of the laser radiation that incides into the removal depression, perpendicular to the normal vector n_{F} on the flank of the removal depression, and that the incident angle w_{E} of the laser radiation w_{E}=90 angular degrees.

An area of damage or the start of a filament, respectively, designated with the reference sign 41, forms in the material of the workpiece.

The arrows 42 indicate the Poynting vectors P (with direction and amount), the time-averaged amount which is also referred to as intensity.

In addition to the Poynting vectors (reference sign 42), the images c) and d) of FIG. 5 show the normal vectors n_{S} onto the non-removed surface and the normal vectors n_{F} onto the removed surface (cut edge, rim of the removal depression). Finally, the incident angle w_{E} of the Poynting vector P on the non-removed surface is indicated in image d) of FIG. 5. As can be recognized based on FIG. 5, the incident angle w_{E} is defined as the angle between the Poynting vector P of the laser radiation and the normal vector n_{S} of the surface where the laser radiation incises. The laser radiation incises either on the flank of the removal depression with the surface normal n_{F} (FIG. 5c) or on the non-removed surface of the surface normal n_{S} (FIG. 5d). The incident angle w_{E} equals the flank angle w, when the Poynting vector runs parallel to the surface normal n_{S} on the non-removed surface of the material (see, for example, FIG. 5c).

According to the invention, the laser radiation is now set to avoid two spatial portions of the radiation being refracted and focused by the entry edge and superimposed in the material such that the threshold value ρ_{damage} for damage is exceeded, thus not reaching the threshold value for removal ρ_{ablation}. As a consequence, cracks/damages of the second kind do not occur.

The expansion of the surroundings of the entry edge is defined in that incident laser radiation in the portion of the entry edge acting in a focusing manner has sufficient power to be able to reach at least the damage threshold of the material. As a consequence, in order to avoid damage in the material occurring due to the laser radiation that is refracted and focused into the material at the entry edge, two quantities need to be taken into account and set correctly, namely the geometric shape of the entry edge and the direction of the incident laser radiation and thus the angle w of the Poynting vector to the normal vector n_{S} located at the non-removed portion of the surface.

As mentioned above, the geometric shape of the entry edge leads to a refraction of the laser radiation and in the most unfavorable case to focusing of the incident laser radiation as illustrated schematically in images and a) and b) of FIG. 5. Ideally, the geometric shape of the entry edge has a sharp edge with no spatial expansion; thus, the geometric shape of the entry edge is ideally one without a curvature (ideally it is an edge with a curvature radius r that assumes the value r=0). In order to achieve a curvature radius near r=0 (with the criteria from the following paragraph), one measure according to the invention is to set a Gaussian rectangle distribution of the incident intensity.

Based on the method according to the invention, the geometric shape of the entry edge is to be set such that the power of the laser radiation that is focused by the entry edge, or is captured from the focusing effect of the entry edge, respectively, is sufficiently small such that the intensity achieved by focusing does not reach the threshold value ρ_{damage} for damaging the material of the workpiece.

The second quantity that is to be taken into account is the direction of the incident laser radiation, i.e., the direction of the Poynting vector P of the laser radiation on the non-removed surface of the workpiece's material. Ideally, the direction of the incident laser radiation should be outside the removal depression, i.e., on the non-removed portion of the workpiece surface, parallel to the normal vector n_{S} on the non-removed surface and inside the removal depression perpendicular to the normal vector n_{F} at the edge of the removal depression.

Based on the method according to the invention, the direction of the incident laser radiation, i.e., the direction of the Poynting vector P of the laser radiation, on the non-removed surface of the workpiece material is tilted in the direction toward the removal depression by an angle w to the normal vector n_{S}, i.e., it forms an incident angle w>=0 on the non-removed surface to the normal vector n_{S} (see image d of FIG. 5) and inside the removal depression is ideally perpendicular to the normal vector n_{F} at the edge of the removal depression.

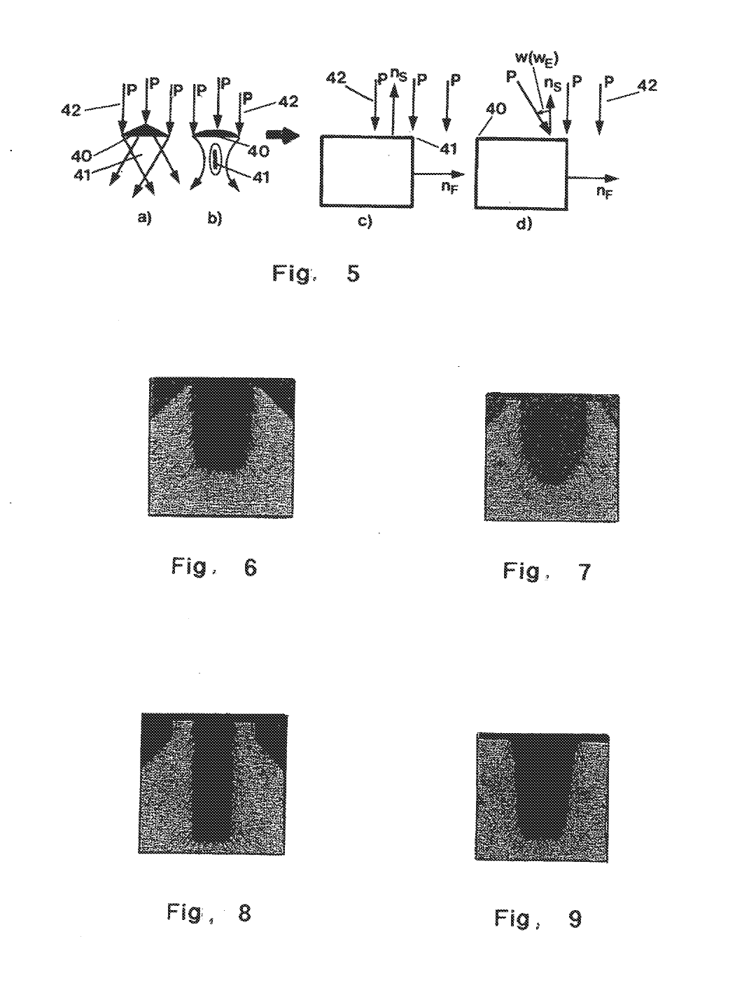

The results of various measures that can be applied to influence the geometric shape of the entry edge are now presented in FIGS. 6 to 9.

FIG. 6 shows the simulated formation of a removal depression that is achieved with an incident laser radiation having a top-hat shape, spatial distribution (i.e. perpendicular to the incident direction) of the intensity of the incident laser radiation. Because of this measure, the region of the entry edge is significantly reduced or does no longer exist and the still existing damages have a significantly smaller penetration depth into the material originating from the entry edge than with a Gaussian spatial distribution of the laser radiation that is typically employed.

FIG. 7 now shows a simulated presentation according to FIG. 6, where, however, the laser radiation does have a spatial distribution of the intensity of the incident laser radiation that is comprised of a top-hat distribution for great distances from the laser beam axis and a Gaussian distribution near the laser beam axis. It can be recognized clearly that here too portions of the laser radiation still result in near parallel removal flanks due to the top-hat distribution in the upper region of the removal depression, however with a round removal bottom, which is a consequence of the portions of the laser radiation due to the Gaussian distribution. Furthermore, the result of this simulation is a somewhat greater penetration depth into the material than is the case when the spatial distribution of intensity of the incident laser radiation is only top-hat-shaped.

For the simulation as shown in FIG. 8, laser radiation with a narrow beam radius (<4 μm) and a Gaussian distribution has been employed. The crack-forming effect of the laser radiation focused from the area of the entry edge, i.e., cracks of the second kind or entry edge damages is no longer present in area of the entry edge.

Only cracks of the third kind, i.e., damages that originate from the surface of the removal depression, which means from the flanks of the removal depression, still occur. Although cracks of the third kind are still present, they are significantly less pronounced and the removal or boring speed assumes higher values. The achievement of smaller flank angles has been demonstrated experimentally.

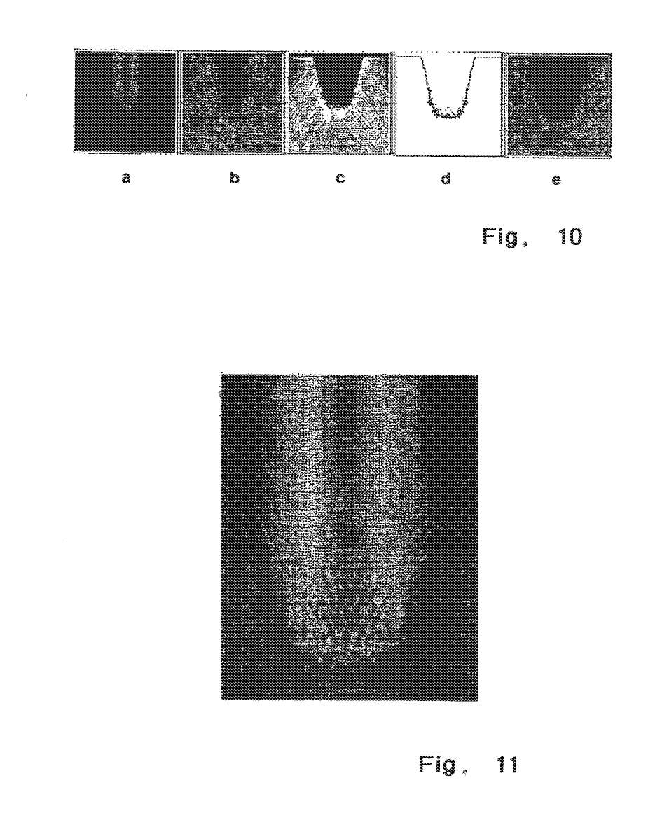

FIG. 9 shows a simulation where the laser radiation is pulsed and the wavelength of the laser radiation alternates from one pulse to the next from 500 nm to 1000 nm. The geometric shape of the advantageously forming large curvature of the area of the entry edge results in a reduction of the focused intensity from the area of the entry edge into the volume, and thus falling below the damage threshold and avoiding this cause for crack formation.

In one embodiment of the method, a wavelength mixture of at least two wavelengths is employed as the laser radiation for the removal. In this case, the at least two wavelengths are selected such that interference patterns arise due to diffraction and refraction in both the material volume and the volume of the removal depression compared to the laser radiation with only one of the wavelengths such that a contrast K in the spatial structure of the intensity distribution is reduced such that in doing so a spatially localized and thus excessive stress of the material is avoided. Here, the contrast K is defined according to Michelson as K=(Imax−Imin)/(Imax+Imin), where I indicates the intensity.

Thus, the contrast between the intensity maxima and intensity minima is reduced, which is otherwise responsible for the diffraction of the laser radiation on the surface or the flanks of the removal depression and due to the ability of the laser radiation to the interference.

Due to the superimposition of laser radiation with at least two different wavelengths according to the invention, a diffraction pattern that is spatially offset in the removal depression is generated for each wavelength. The at least two wavelengths, also in connection with the setting of the powers and focus radii of the respective laser radiation, can be selected such that the diffraction maxima of the laser radiation with the first wavelength occur in the locations, where the diffraction minima of the laser radiation with the second wavelength are located. As a result of this superimposition, the contrast of the superimposed diffraction structure becomes significantly smaller.

FIG. 10 illustrates in the image sequence of the images a to e again the formation of cracks of the third kind as can be seen in the last image e of the image sequence, after 8 pulses of a laser radiation.

Image a shows the causative distribution of the intensity in the removal depression, image b that in the brittle-hard material. Image c presents the free electron density, image d the surface of the removal depression and image e the resulting distribution of modifications/damages/cracks after eight pulses of laser radiation.

Based on the images of FIG. 10 one can recognize that the spatial structure of the intensity distribution continues in the removal depression (image a) in an unwanted strongly pronounced spatial structure of the intensity of the laser radiation in the brittle-hard material (image b). In the result, the geometric shape of the surface of the removal depression (image d), the generated density of free electrons (image c) and the modifications/damages (image e) are spatially structured and unwanted cracks of the third kind develop.

The spatial expansion of the graphs is 40 μm in both directions to illustrate the size proportions.

The deviation of the intensity of the laser beam from a spatially poorly variable distribution is designated as contrast, as used here, as would exist in the removal depression for an undisturbed propagating laser radiation (image a of FIG. 10).

This contrast in the spatial distribution of the intensity in the removal depression that is to be reduced is shown once more in the magnified FIG. 11. According to one embodiment of the invention, this contrast in the spatial structure of the intensity distribution in the removal depression is reduced by superimposing laser radiation with at least two different wavelengths.

According to the invention, it is not the power of the laser radiation that is reduced to avoid damage but rather according to the invention, the geometric shape of the entry edge is set by setting the spatial distribution of the power such that the focusing effect of the entry edge is reduced. Thus, according to the invention, with great power, and as a result with a desirable great removal rate, the portion of the power that is captured and focused by the entry edge and in this manner leads to unwanted damage is reduced.

According to the invention, cutting can take place with high power in one step, yet a small expansion of the entry edge can still be formed. As a consequence of the small expansion of the entry edge, only a smaller portion of the power is focused into the material, thus avoiding damage.

There has thus been shown and described a novel method for removing brittle-hard material by means of laser radiation which fulfills all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. In a method for removing brittle-hard material from a substrate by means of laser radiation, wherein a removal depression having a flank angle w of the flanks of the removal depression forms in the material as a result of the removal, wherein the flank angle w is defined as the angle between the surface normal on the flank of the removal depression and the surface normal on the unremoved surface of the material, and forms with an entry edge, which is defined as a spatially expanded region of the surface of the material, where an unchanged and thus unremoved portion of the surface of the material transitions into the removal depression, and at which spatial portions of the power of the laser radiation are refracted and focused into the volume of the unremoved material, the improvement comprising the step of setting the distribution of the laser radiation such that the entry edge assumes a spatial expansion such that said portion of the power of the laser radiation that is captured by the focusing effect of the entry edge is not sufficient to generate a threshold value ρ_{damage} for the electron density in the volume of the material, thus avoiding damage to the material.

2. Method as in claim 1, wherein the Poynting vector P is set by the portion of the laser radiation incident on the unremoved surface of the material in the region of the removal depression tilted toward the entry edge and wherein the incident angle w_{E} of the laser radiation is not less than zero (w_{E}>=0 angular degrees), whereby the incident angle w_{E} is defined as the angle between the Poynting vector P of the laser radiation and the normal vector of the surface impacted by the laser radiation.

3. Method as in claim 1, wherein the Poynting vector P is set by the portion of the laser radiation that impacts the removal depression in the region of the entry edge, perpendicular to the normal vector n_{F} on the flank of the removal depression, and wherein the incident angle w_{E} of the laser radiation w_{E}=90 angular degrees, whereby the incident angle w_{E} is defined as the angle between the Poynting vector P of the laser radiation and the normal vector of the surface that is impacted by the laser radiation.

4. Method as in claim 1, wherein the spatial distribution of the laser radiation at the entry into the removal depression is set to be rectangular when viewed perpendicular to the direction of the laser beam axis.

5. Method as in claim 1, wherein the spatial distribution of the laser radiation at the entry into the removal depression is set to a Gaussian shape and wherein the Gaussian distribution is cut off in a rectangular shape at a distance from the beam axis where the intensity in the material reaches a threshold value ρ_{damage} for the damage to the material, and wherein the intensity is zero for greater distances from the beam axis.

6. Method as in claim 1, wherein a wavelength mixture of at least two wavelengths is employed for the laser radiation for the removal, and said at least two wavelengths are selected such that interference diffraction patterns arise due to the diffraction and refraction along the surfaces of the removal depression and in the material volume of material compared to laser radiation of only one of the wavelengths such that a contrast K in the spatial structure of the intensity distribution is reduced, whereby the contrast K is defined according to Michelson as K=(Imax−Imin)/(Imax+Imin), wherein Imax and Imin indicate the maximum and minimum intensities of the spatial structure of the intensity distribution.

7. Method as in claim 6, wherein the wavelength mixture is selected from said at least two wavelengths such that spatial positions of interference maxima of one of the wavelength(s) coincide with interference minima of the other wavelength(s).

8. Method as in claim 7, wherein additional wavelengths to said at least two wavelengths are selected such that they are integer multipliers or divisors of said at least two wavelengths.

9. Method as in claim 6, wherein a separate laser provides each wavelength.

10. Method as in claim 6, wherein the different wavelengths are provided by one laser source, the wavelength of which is modulated over time.
